(19) United States
(12) Patent Application Publication
(10) Pub. No.: US 2021/0289753 A1
(43) Pub. Date: Sep. 23, 2021

(54) Pet Leash with Interchangeable Components and Accessory Pouch

(71) Applicant: Cammie Bradford, Herndon, PA (US)

(72) Inventor: Cammie Bradford, Herndon, PA (US)

(21) Appl. No.: 17/186,968

(22) Filed: Feb. 26, 2021

Related U.S. Application Data
(60) Provisional application No. 62/992,337, filed on Mar. 20, 2020.

(51) Int. Cl. A01K 27/00

(52) U.S. Cl. CPC A01K 27/008; A01K 27/006; G09F 3/00; A01K 27/001; A01K 27/005

(57) ABSTRACT

A pet leash with interchangeable attachments is an apparatus that intends to provide pet owners a convenient way of aesthetically matching a collar/harness of a pet, to the handle of the leash. Further, it is an aim of the apparatus to enable users to hold multiple items, such as small accessories, disposable waste bags, treats for the pet etc., as they take a stroll with their pet on the leash. In order to accomplish this, the apparatus comprises a handle, at least one accessory strap attachment with a sealed pouch/bag, and a leash. Furthermore, the handle, the strap attachments and the leash are detachably connected with the help of multiple fasteners. Thus, the apparatus allows users to have a combination of attachments as part of their pet leash, that are both aesthetically pleasing as well as convenient.

The current application claims a priority to the U.S. Provisional Patent application Ser. No. 62/992,337 filed on Mar. 20, 2020.

### FIELD OF THE INVENTION

The present invention relates to a pet leash. More specifically, the present invention provides the user a convenient way of swapping to an aesthetically pleasing combination of collar, leash, and handle for their pet.

### BACKGROUND OF THE INVENTION

When it comes to collars and leashes of a pet, pet owners may have excessive number of leashes laying around the house or an excessive number of leashes to choose from when going for walks. The pet owner may want to choose the best leash that will aesthetically look pleasing in combination with the collar of the pet. Another issue that pet-owners may come across is the lack of an accessory carrier when going for walks with their pet. For example, the pet owner may want to go for a walk with multiple small accessories but may not have enough space in their pockets and does not want to carry a small baggage in order to carry something small such as extra waste bag holders.

An objective of the present invention is to provide pet owners a convenient way of aesthetically matching collar/harness to the handles of their leashes. To accomplish this the present invention comprises a leash that has a snap on handle, that that may be interchanged and swapped according to the user's preference, to match the collar/harness of a pet. It is further an aim of the present invention to provide a leash with an accessory pouch. To accomplish this, the present invention discusses integrating three separate carrier bags attached to separate detachable straps, so as to enable users to hold multiple items, such as small accessories, disposable waste bags, treats for the pet etc. Accordingly, the present invention comprises a handle, at least one accessory pouch, and a leash that are connected with the help of multiple quick release fasteners. Thus, the present invention provides users with an aesthetically pleasing, user-friendly, and efficient pet leash.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a top-front-right perspective view of the present invention, without a collar.

FIG. 4 is an exploded view of FIG. 3.

FIG. 5 is a top-front-left perspective view of the present invention with one strap attachment and no collar.

FIG. 6 is a perspective view of a handle, according to a preferred embodiment of the present invention.

FIG. 7 is a top perspective view of the strap attachment and a receptacle, according to the preferred embodiment of the present invention.

FIG. 8 is an exploded view of FIG. 7.

FIG. 9 is a perspective view of a leash, according to the present invention.

FIG. 10 is a perspective view of the collar, according to the present invention.

### DETAIL DESCRIPTIONS OF THE INVENTION

All illustrations of the drawings are for the purpose of describing selected versions of the present invention and are not intended to limit the scope of the present invention.

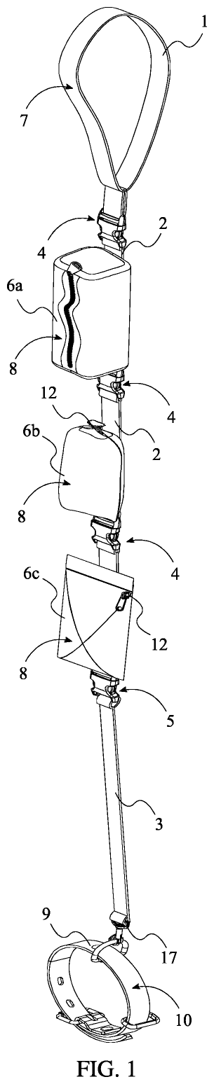

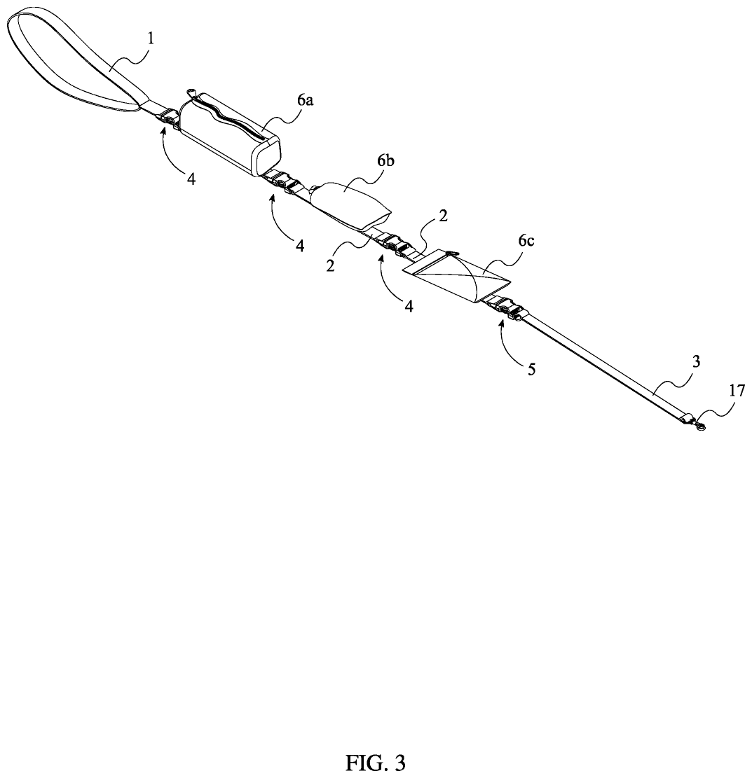

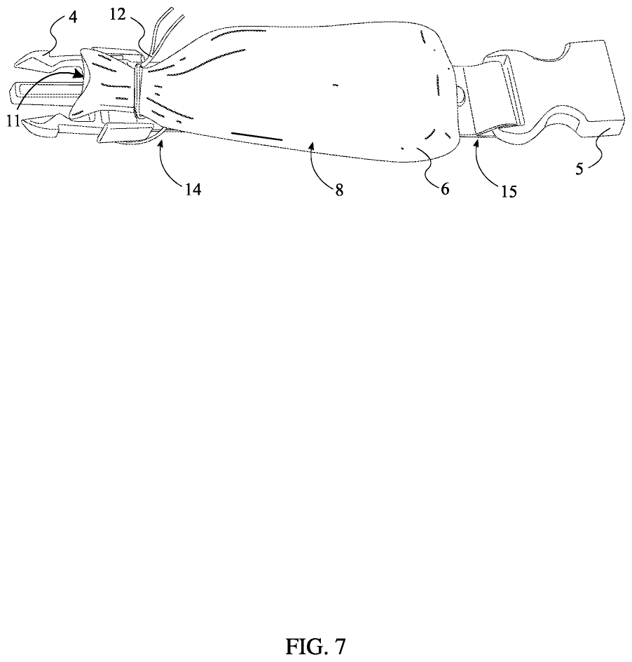

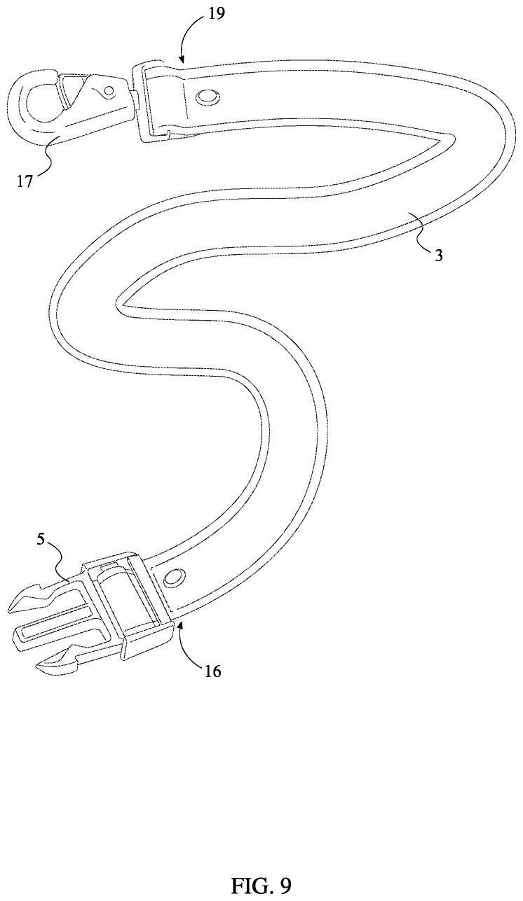

In reference to FIG. 1 through FIG. 10, the present invention is a pet leash with multiple detachable components. An objective of the present invention is to provide pet owners a convenient way of aesthetically matching collar/harness to the handles and leashes. In other words, it is an aim of the present invention to provide users with a leash that has an interchangeable snap on handle, that that may be interchanged and swapped according to the user's preference, to match the collar/harness of a pet. Further, three separate carrier bags attached to separate detachable straps enable users to hold multiple items, such as small accessories, disposable waste bags, treats for the pet etc. Accordingly, the pet leash comprises a handle, three strap attachments wherein each strap attachment holds a sealed pouch/bag, and a leash. Furthermore, the handle, the strap attachments and the leash are detachably connected with the help of multiple fasteners. Thus, the present invention allows users to have a combination of interchangeable components as part of their pet leash, that are both aesthetically pleasing as well as efficient.

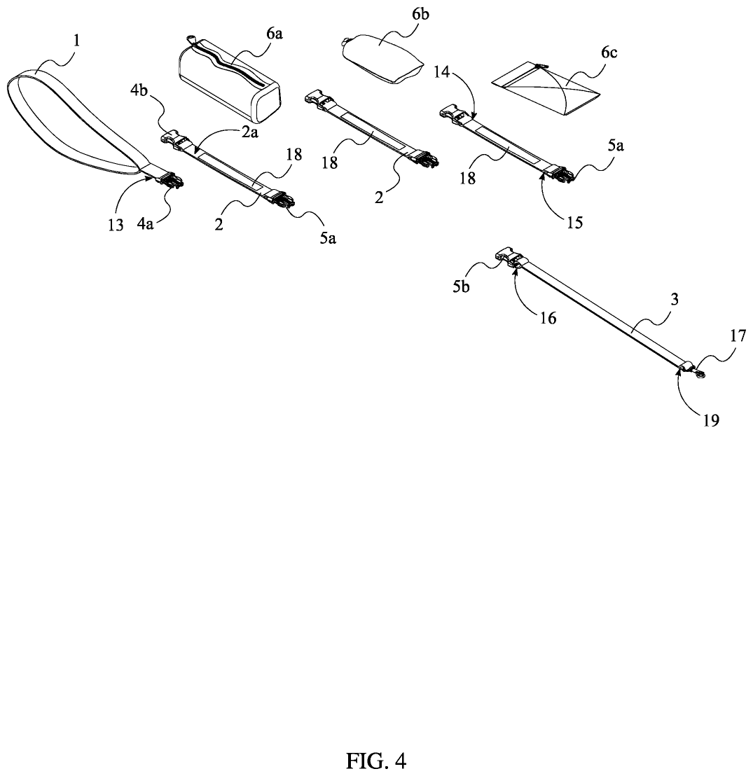

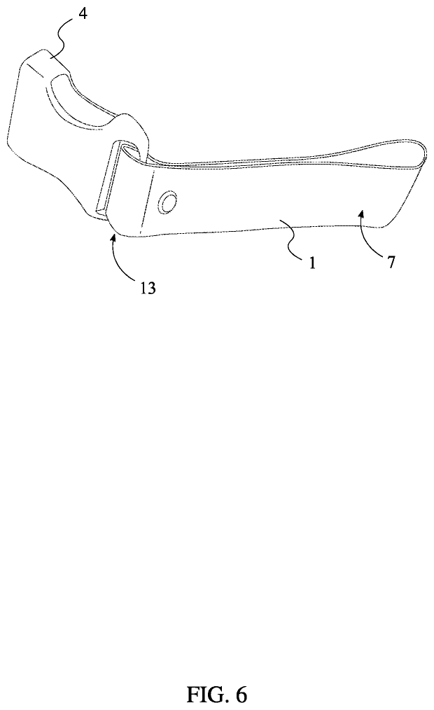

The following description is in reference to FIG. 1 through FIG. 10. According to a preferred embodiment, the present invention comprises a handle 1, at least one accessory strap 2, a leash 3, a handle fastener 4, and a strap fastener 5. In the preferred embodiment, the handle 1 of the present invention is used to hold and maintain the leash 3 of a pet. Preferably, the handle 1 is custom designed, and is made with cotton/eco-canvas fabric, heavy duty nylon webbing and strong threading. Further, as seen in FIG. 6, the handle 1 comprises a loop structure in which the loop is used to be held by the user to maintain the leash and control of a pet. However, the handle 1 may comprise any other material, size, shape, components, and arrangement of components, that are known to one of ordinary skill in the art, as long as the objectives of the present invention are fulfilled. Furthermore, in order to accomplish the smooth functioning and objectives of the present invention, the handle 1 is terminally mounted onto the at least one accessory strap 2. To accomplish this, the handle fastener 4 is detachably connected in between the handle 1 and the at least one accessory strap 2. As seen in FIG. 4, the handle fastener 4 comprises a male buckle end 4a and a female buckle end 4b, wherein the male buckle end 4a and the female buckle end 4b are separately mounted to, at least one of, the handle 1 and the at least one accessory strap 2. Further, the attachment between the handle 1 and the accessory strap 2 is done by inserting the male buckle end 4a of the handle fastener 4 into the female buckle end 4b of the handle fastener 4. However, the handle fastener 4 may comprise any other fastener or fastening technology, that is known to one of ordinary skill in the art, as long as the intents of the present invention are not altered.

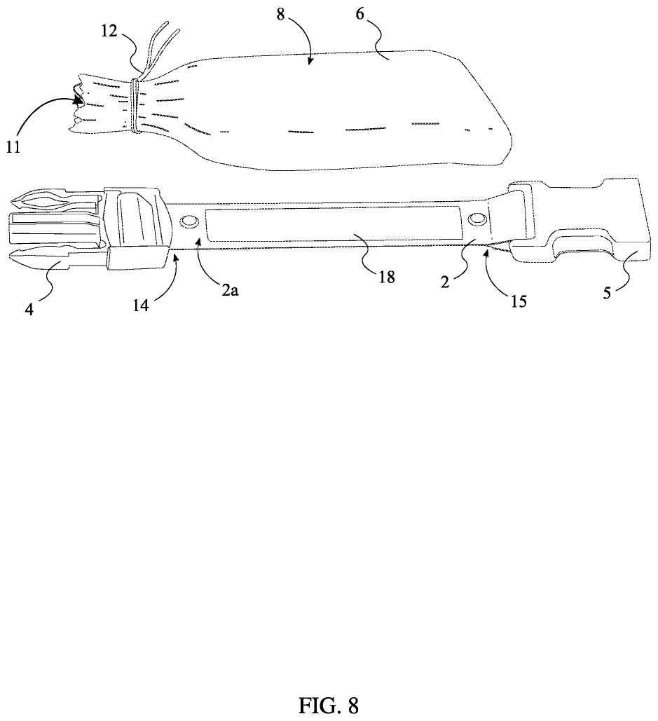

It is an aim of the present invention to provide an accessory pouch for holding in miscellaneous items, such as keys, waste bags, treats etc. while the user takes a walk with their pet on the pet leash. To accomplish this, the at least one accessory strap 2 comprises a receptacle 6. The receptacle 6 may comprise any shape and cater to different functionality. Preferably, the receptacle 6 is 5-6 inches in length and the receptacle 6 is compressible. As seen in FIG. 1 through FIG. 4, three different accessory straps 2 may comprise three different kinds of receptacles 6. For example, the receptacle 6 may be a waste bag holder 6a with a parallel opening, a treat/bait bag 6b with a pull string closure, or an accessory bag 6c for the user's personal accessories. The accessory bag 6c for the user's personal accessories is a misc. bag that can carry keys, wallet, IDs, etc. In other words, the receptacle 6 is a resealable pouch that may be used for different functionalities. However, it should be noted that, the receptacle 6 may comprise any different shape, size, material, components, and arrangement of components that are known to one of ordinary skill in the art, as long as the intents of the present invention are fulfilled. Further, as clearly seen in FIG. 8, the receptacle 6 is detachably mounted adjacent a planar surface 2a of the at least one accessory strap 2.

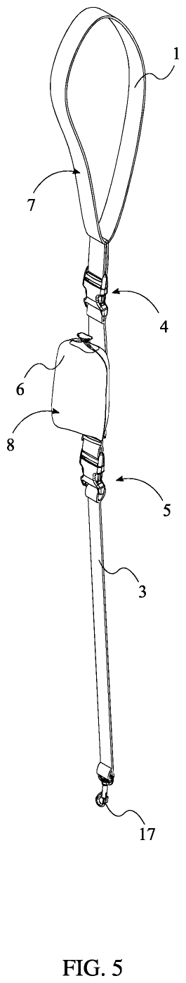

As seen in FIG. 1 through FIG. 5, the at least one accessory strap 2 is detachably mounted between the handle 1 and the leash 3. In other words, the at least one accessory strap 2 is the connector between the handle 1 and the leash 3. Accordingly, the user may choose to include or remove/swap between, any one or as many accessory straps 2 in between in handle 1 and the leash 3. For example, as seen in FIG. 5, a single accessory strap 2 with a pouch shaped receptacle 6 is mounted between the handle 1 and the leash 3. Accordingly, the leash 3 is terminally mounted onto the at least one accessory strap 2. To accomplish this, the strap fastener 5 is detachably connected between the at least one accessory strap 2 and the leash 3. As seen in FIG. 4, the strap fastener 5 comprises a male buckle end 5a and a female buckle end 5b, wherein the male buckle end 5a and the female buckle end 5b are separately mounted to the at least one accessory strap 2 and the leash 3 respectively. Further, the attachment between the leash 3 and the accessory strap 2 is done by inserting the male buckle end 5a of the strap fastener 5 into the female buckle end 5b of the strap fastener 5. However, the strap fastener 5 may comprise any other fastener or fastening technology, that is known to one of ordinary skill in the art, as long as the intents of the present invention are not altered.

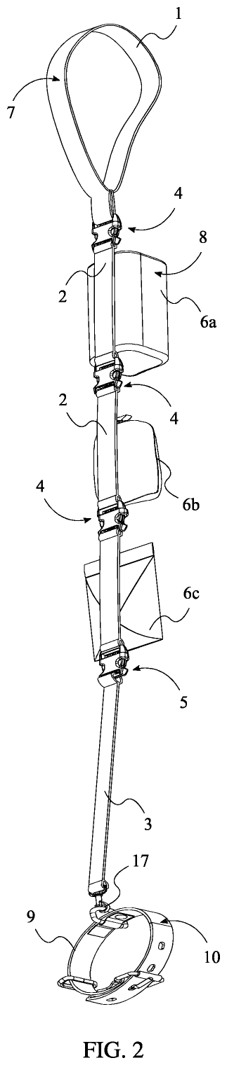

As seen in FIG. 1 and FIG. 2, the leash 3 is terminally mounted onto the at least one accessory strap 2. According to the preferred embodiment, the leash 3 is universal to the present invention. This is because, since the at least one accessory strap 2 and handle 1 may be interchanged, this allows the user to use only one leash 3 and a variety of strap attachments and handles. Preferably, the leash 3 comprises a neutral color that fits with almost every combination of collars/harnesses and handles, such that the leash 3 does not necessarily need to be replaced unless the user desires to. However, the leash 3 may comprise any color, length, material, components, and arrangement of components that are known to one of ordinary skill in the art, as long as the objectives of the present invention are not altered.

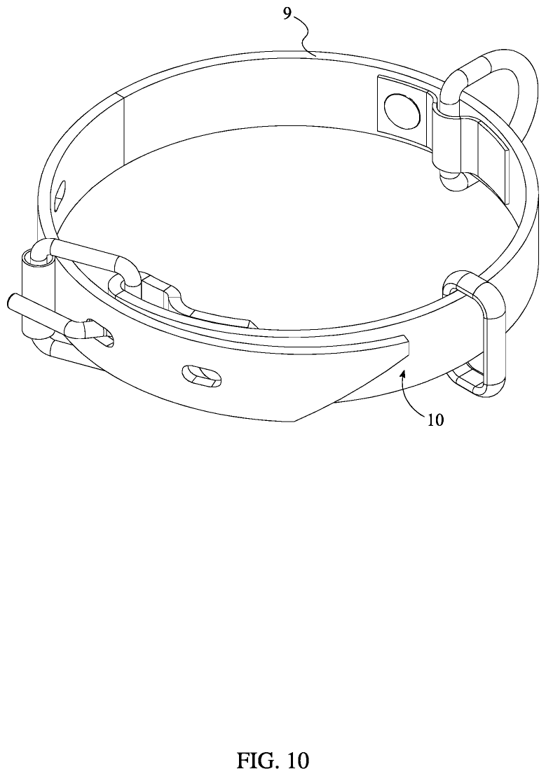

It is an aim of the present invention to provide users with an aesthetically appealing pet leash. In order to accomplish this, the present invention comprises a first display device 7 and a second display device 8, wherein the first display device 7 is mounted onto the handle 1, and the second display device 8 is mounted onto the receptacle 6. Preferably, the first display device 7 and the second display device 8 comprise a fabric of similar color or pattern. However, the first display device 7 and the second display device 8 may comprise any specific design or logo, or interchangeable tokens, like nametags, that are known to one of ordinary skill in the art, provided the first display device 7 and the second display device 8 together are aesthetically appealing. Continuing with the preferred embodiment, the present invention comprises a collar 9. As seen in FIG. 10, the collar 9 is an adjustable belt that goes around the neck of a pet and comprises multiple attachment means. However, the collar 9 may comprise any other size, shape, components, and arrangement of components that are known to one of ordinary skill in the art, as long as the objectives of the present invention are fulfilled. In the preferred embodiment, the collar 9 is detachably connected to the leash 3, and the collar 9 comprises a third display device 10. The collar 9 of the present invention also aims at providing an aesthetically pleasing and matching element to the pet leash. Accordingly, the third display device 10 is mounted onto the collar 9, wherein the third display device 9 and the first display device 7 together are aesthetically appealing. Preferably, the third display device 10 is a fabric with a specific color or pattern. However, the third display device 10 may comprise any specific design or logo, or interchangeable tokens, like nametags, that are known to one of ordinary skill in the art, as long as the first display device and the third display device together are aesthetically appealing. Thus, the user may interchange/swap the handle 1, the at least one accessory strap 2, and/or the collar 9, to match the leash 3 and thus have an aesthetically appealing combination of leash 3 and collar 9 to go around the pet.

In order to provide access to the receptacle 6 and securely hold the user's desired accessories and contents within the receptacle 6, the present invention comprises an access aperture 11. Preferably, the access aperture traverses into the receptacle 6 and the access aperture 11 acts as an entry way for putting in various articles into the receptacle 6. As seen in FIG. 1, and FIG. 2, different kinds of receptacles 6 may comprise different kinds of access apertures 11. For example, the access aperture 11 could be a front opening like a slit if the receptacle 6 is a bag for holding waste bags, or a big opening at the top end of a pouch, if the receptacle 6 is a treat bag, as shown in FIG. 8. However, the access aperture 11 may comprise any other dimension, location, shape etc., as long as the intents of the present invention are fulfilled. Further, to securely hold the contents of the receptacle 6, the present invention comprises a covering fastener 12, wherein the covering fastener 12 is operably engaged with the access aperture 11. The covering fastener 12 works in such a way that operating the covering fastener 12 governs opening and closing of the access aperture 11. The covering fastener 12 may comprise any fastener and fastening technique, such as a zipper, hook and loop fastener, pull string, snap ties, magnetic fastener etc. as long as the intents of the present invention are not altered.

As seen in FIG. 4, the handle fastener 4 is connected between a terminal end 13 of the handle 1 and a first terminal end 14 of the at least one accessory strap 2. This is so that the user may easily un-fasten and swap handles to match with the leash and/or the accessory strap. Similarly, the strap fastener 5 is connected being between a second terminal end 15 of the at least one accessory strap 2 and a third terminal end 16 of the leash 3. This arrangement enables users to remove and snap back on the desired accessory strap 2 and receptacle 6 with ease, according to the users' aesthetic and functional preference.

In order to accomplish the smooth functioning of the present invention, the pet leash further comprises a leash fastener 17 and a receptacle fastener 18. According to the preferred embodiment, the leash fastener 17 is integrated between a fourth terminal end 19 of the leash 3 and the collar 9. Preferably, the leash fastener 17 comprises a hook attachment piece, wherein the hook attachment piece is used to hook onto the collar 9 or harness of the pet. The leash fastener 17 allows the user to change to different sets of collars 9 such that the overall apparatus is aesthetically pleasing. Further, the receptacle fastener 18 is integrated between the receptacle 6 and the at least one accessory strap 2. In other words, receptacle 6 will be attached to the at least one accessory strap 2 by means of the receptacle fastener 18.

As seen in FIG. 8, the receptacle fastener 18 comprises a hook and loop fastener, wherein, the hook end is stitched on to a bottom surface of the receptacle 6 and the loop end is stitched onto the planar surface 2a of the at least one accessory strap 2. However, the leash fastener 17 and the receptacle fastener 18 may comprise fasteners of any other shape, size and technology, that are known to one of ordinary skill in the art, as long as the intents of the present invention are not altered. Examples of such fasteners include, but are not limited to snap buttons, d-clips, stiches, magnetic fasteners etc.

Although the invention has been explained in relation to its preferred embodiment, it is to be understood that many other possible modifications and variations can be made without departing from the spirit and scope of the invention as hereinafter claimed.

What is claimed is:

1. A pet leash with interchangeable components, comprising:
a handle;
at least one accessory strap;
a leash;
a handle fastener; and
a strap fastener;
the at least one accessory strap comprising a receptacle;
the handle being terminally mounted onto the at least one accessory strap;
the at least one accessory strap being detachably mounted between the handle and the leash;
the leash being terminally mounted onto the at least one accessory strap;
the handle fastener being detachably connected between the handle and the at least one accessory strap;
the strap fastener being detachably connected between the at least one accessory strap and the leash; and
the receptacle being detachably mounted adjacent a planar surface of the at least one accessory strap.

2. The pet leash of claim 1, comprising:
a first display device;
a second display device;
the first display device being mounted onto the handle; and
the second display device being mounted onto the receptacle.

3. The pet leash of claim 2, wherein the first display device and the second display device together being aesthetically appealing.

4. The pet leash of claim 2, comprising:
a collar;
a third display device;
the collar being detachably connected to the leash; and
the third display device being mounted onto the collar, wherein the third display device and the first display device together being aesthetically appealing.

5. The pet leash of claim 1, comprising:
an access aperture; and
the access aperture traversing into the receptacle.

6. The pet leash of claim 5, comprising:
a covering fastener;
the covering fastener being operably engaged with the access aperture, such that operating the covering fastener governs opening and closing of the access aperture.

7. The pet leash of claim 1, wherein the handle fastener being connected between a terminal end of the handle and a first terminal end of the at least one accessory strap.

8. The pet leash of claim 1, wherein the strap fastener being connected being between a second terminal end of the at least one accessory strap and a third terminal end of the leash.

9. The pet leash of claim 1, comprising:
a leash fastener; and
a receptacle fastener;
the leash fastener being integrated between a fourth terminal end of the leash and a collar;
the receptacle fastener being integrated between the receptacle and the at least one accessory strap.

10. The pet leash of claim 1 wherein the handle being a loop.

11. The pet leash of claim 1, wherein the receptacle being a resealable pouch.

12. The pet leash of claim 1, wherein the receptacle being compressible.

13. A pet leash with interchangeable components, comprising:
a handle;
a first display device;
at least one accessory strap;
a leash;
a handle fastener; and
a strap fastener;
a second display device;
the at least one accessory strap comprising a receptacle;
the handle being terminally mounted onto the at least one accessory strap;
the first display device being mounted onto the handle;
the at least one accessory strap being detachably mounted between the handle and the leash;
the leash being terminally mounted onto the at least one accessory strap;
the handle fastener being detachably connected between the handle and the at least one accessory strap;
the strap fastener being detachably connected between the at least one accessory strap and the leash; and
the receptacle being detachably mounted adjacent a planar surface of the at least one accessory strap;
the second display device being mounted onto the receptacle; and
the first display device and the second display device together being aesthetically appealing.

14. The pet leash of claim 13, comprising:
a collar;
a third display device;
the collar being detachably connected to the leash; and
the third display device being mounted onto the collar, wherein the third display device and the first display device together being aesthetically appealing.

15. The pet leash of claim 13, comprising:
an access aperture;
a covering fastener;
the access aperture traversing into the receptacle; and
the covering fastener being operably engaged with the access aperture, such that operating the covering fastener governs opening and closing of the access aperture.

16. The pet leash of claim 13, wherein the handle fastener being connected between a terminal end of the handle and a first terminal end of the at least one accessory strap.

17. The pet leash of claim 13, wherein the strap fastener being connected being between a second terminal end of the at least one accessory strap and a third terminal end of the leash.

18. The pet leash of claim 13, comprising:
a leash fastener; and
a receptacle fastener;
the leash fastener being integrated between a fourth terminal end of the leash and a collar;
the receptacle fastener being integrated between the receptacle and the at least one accessory strap.

19. The pet leash of claim 1, wherein the receptacle being a resealable pouch.

20. The pet leash of claim 1, wherein the receptacle being compressible.
